(19) United States
(12) Patent Application Publication
(10) Pub. No.: US 2009/0251382 A1
(43) Pub. Date: Oct. 8, 2009

(54) ANTENNA DEVICE AND COMMUNICATION DEVICE USING SAME

(76) Inventor: Naoko Umehara, Takatsuki-shi (JP)

Correspondence Address: BIRCH STEWART KOLASCH & BIRCH, PO BOX 747, FALLS CHURCH, VA, 22040-0747, US

(21) Appl. No.: 12/408,421

(22) Filed: Mar. 20, 2009

(30) Foreign Application Priority Data
Apr. 4, 2008 (JP) 2008-098150

(51) Int. Cl. H01Q 1/50

(52) U.S. Cl. 343/850

(57) ABSTRACT

An antenna device of the present invention includes a radiating element and a matching circuit connected to the radiating element and provided with capacitance elements. In the antenna device, a PIN diode is employed as one of the capacitance elements, and the capacitance of the PIN diode is controlled such that a resonant frequency is controlled. Thus, it is possible not only to simply the matching circuit and reduce the size thereof with ease but also to shift the resonant frequency with a relatively low voltage. This makes it easy to prevent as much as possible a decrease in radiation efficiency.

### CROSS-REFERENCE TO RELATED APPLICATIONS

This nonprovisional application claims priority under 35 U.S.C. § 119 (a) on Patent Application No. 2008-098150 filed in Japan on Apr. 4, 2008, the entire contents of which are hereby incorporated by reference.

### BACKGROUND OF THE INVENTION

1. Field of the Invention

The present invention relates to an antenna device for use in wireless communication and a communication device incorporating such an antenna device.

2. Description of the Related Art

In recent years, compact mobile communication devices such as mobile telephones have incorporated more and more features such as for receiving television broadcasts. Thus, it becomes necessary for communication devices to receive radio waves in a wide frequency band.

The length of an antenna for use in wireless communication generally corresponds to the wavelength of a radio wave serving as a communication medium. As the wavelength of the radio wave becomes longer, that is, as the frequency thereof becomes lower, the length of the antenna is set longer. In radio waves used for television broadcasts, the UHF band ranges from 470 MHz to 770 MHz and the VHF band ranges from 90 MHz to 222 MHz. In a case, for example, where a radio wave of 500 MHz is received by a household antenna, the length of the radiating element of the antenna is set at λ/2 (=300 mm).

However, as a portable communication device or the like becomes more compact, it becomes small with respect to the wavelength of a radio wave serving as a communication medium; this makes it difficult to mount, on such a communication device, a long antenna suitable for communication. Moreover, there is a tendency to desire an integral antenna in terms of the appearance and portability of a communication device. Thus, it becomes more and more difficult to provide a space where an antenna is mounted.

There have been proposed a variety of antenna devices that are conventionally used in portable communication devices or the like and that can shift their frequencies to achieve wireless communication. For example, in JP-A-2004-320611 (patent document 1), there is proposed an antenna device that has, near a feeding point, a matching circuit incorporating a variable capacitance diode and that varies the capacitance of the variable capacitance diode to vary the degree of matching. With this antenna device, it is possible to shift its frequency to achieve wireless communication by varying the degree of matching.

In JP-A-2006-140662 (patent document 2), there is proposed an antenna device that can achieve reception over a wide frequency range because a variable capacitance element is connected between the divided portions of the first radiating conductor wound around a dielectric member, a switch element is connected between the second radiating conductor wound around the dielectric member and the first radiating conductor, the switch element is turned on and off and the capacitance of the variable capacitance element is varied.

Disadvantageously, however, as proposed in patent document 1, in an antenna device that shifts its resonant frequency with a variable capacitance diode alone, a plurality of variable capacitance diodes are required so that the resonant frequency is shifted sufficiently. This may prevent a circuit from being simplified and reduced in size. Moreover, in order to control the capacitance of the variable capacitance diode, it is necessary to use a relatively high voltage (as compared with a PIN diode or the like). Thus, if such an antenna device is employed in a mobile device that is desired be controlled by a low voltage, problems are more likely to arise.

In the antenna device proposed in patent document 2, a large number of patterns used for control are connected to its radiating element, and thus its radiation efficiency may be reduced that is the most important factor to the performance of an antenna for use in a mobile device. Since an integral antenna is inherently disadvantageous in terms of radiation efficiency as compared with an external antenna, it is necessary to prevent as much as possible a decrease in radiation efficiency. Since a large number of semiconductor elements are used, the antenna device is impractical in terms of cost.

### SUMMARY OF THE INVENTION

An object of the present invention is to provide an antenna device in which a matching circuit is easily simplified and reduced in size, its resonant frequency can be shifted by a relatively low voltage and furthermore, it is easy to prevent as much as possible a decrease in radiation efficiency.

To achieve the above object, according to one aspect of the present invention, there is provided an antenna device including a radiating element and a matching circuit connected to the radiating element and provided with capacitance elements. In the antenna device, a PIN diode is employed as at least one of the capacitance elements, and the capacitance of the PIN diode is controlled such that a resonant frequency is controlled.

Generally, the capacitance of a PIN diode can be varied significantly as compared with a variable capacitance diode. Thus, with this configuration, it is possible to reduce the number of capacitance elements that are needed to shift a resonant frequency by a predetermined amount as compared with an antenna device in which the PIN diode is not employed as the capacitance element in the matching circuit. Hence, it is possible to simplify the matching circuit and reduce the size thereof with ease.

Generally, in a PIN diode, a voltage (control voltage) that is needed to vary its capacitance by a predetermined amount can be reduced as compared with a variable capacitance diode. Thus, with this configuration, it is possible to shift a resonant frequency with a low voltage as compared with the antenna device in which the PIN diode is not employed as the capacitance element in the matching circuit.

With this configuration, it is possible to vary frequency characteristics such as a VSWR by controlling the matching circuit. Hence, unlike the antenna device of patent document 2 described previously, it is not necessary to connect a control pattern or the like to the radiating element, and this makes it easy to prevent as much as possible a decrease in radiation efficiency.

More specifically, the antenna device configured as described above may further include an RF terminal connected to the radiating element through the matching circuit. In this antenna device, the PIN diode may be inserted into an RF line through which the radiating element and the RF terminal are connected and through which an RF signal is transmitted.

More specifically, in the antenna device configured as described above, the PIN diode may be inserted into a feeding line connecting the radiating element and a feeding point.

The antenna device configured as described above may include a plurality of the PIN diodes. With this configuration, it is possible to extend the range over which the resonant frequency is varied by individually controlling the capacitances of the PIN diodes as compared with an antenna device in which the capacitance of one PIN diode is controlled.

In the antenna device configured as described above, a variable capacitance diode employed as one of the capacitance elements may be inserted into the RF line so as to be connected in series to the PIN diode.

Generally, the capacitance of a variable capacitance diode is easily varied in an analog manner (continuously), as compared with a PIN diode. Thus, with this configuration, it is possible not only to obtain benefits resulting from the above-described configuration but also to easily vary a resonant frequency in an analog manner.

In the antenna device configured as described above, the radiating element may be a conductor pattern formed on a predetermined dielectric member. With this configuration, it is possible to reduce the size of the antenna device. Thus, it is desirable as a variable-frequency antenna incorporated into, for example, a portable communication device.

More specifically, in the antenna device configured as described above, the conductor pattern may be formed in one of a meandering shape, a helical shape, an inverted F-shape and an inverted L-shape.

In the antenna device configured as described above, the conductor pattern may be formed in a meandering shape on a plurality of surfaces of the dielectric member. With this configuration, it is possible to further reduce the size of the antenna device.

In the antenna device configured as described above, a chip coil may be inserted into a line connecting the radiating element and the PIN diode. With this configuration, it is possible to complement the length of the antenna even if, for example, the length of the antenna is not long enough for a predetermined wavelength because the radiating element formed as the conductor pattern is only available.

The antenna device configured as described above may be configured such that a variable capacitance diode employed as one of the capacitance elements is inserted in series into the RF line, a chip coil is inserted into a line connecting the radiating element and the PIN diode and a chip component constituting one of the PIN diode, the variable capacitance diode, the chip coil and the matching circuit is mounted on the dielectric member.

With this configuration, it is not necessary to provide another space in which the chip components are mounted. This makes it possible to minimize the space in which components are mounted.

According to another aspect of the present invention, there is provided a communication device including the antenna device configured as described above and a communication module that wirelessly communicates externally through the antenna device and that controls the capacitance of the PIN diode.

With this configuration, it is possible to wirelessly communicate using the antenna device configured as described above. It is also possible to control a resonant frequency by controlling the capacitance of the PIN diode in the antenna device configured as described above.

According to another aspect of the invention, there is provided a communication device including the antenna device configured as described above and a communication module that wirelessly communicates externally through the antenna device and that controls the capacitance of the PIN diode and the capacitance of the variable capacitance diode.

With this configuration, it is possible to wirelessly communicate using the antenna device configured as described above. It is also possible to control a resonant frequency by controlling the capacitance of the PIN diode and the capacitance of the variable capacitance diode in the antenna device configured as described above.

In the communication device configured as described above, the communication module may perform the control according to a frequency used in the wireless communication, and the VSWR of the antenna device may be controlled by the control.

With this configuration, by controlling the capacitance of the PIN diode and the like, it is possible to control the VSWR of the antenna device such that the minimum of the VSWR is reached at a frequency used in wireless communication.

### BRIEF DESCRIPTION OF THE DRAWINGS

These and other objects and features of the present invention will be more apparent from the following description of the preferred examples and the accompanying drawings in which:

FIG. 1 is a diagram showing the configuration of an antenna device according to example 1 of the present invention;

FIG. 2 is a diagram showing the configuration of an antenna device according to example 2 of the invention;

FIG. 3 is a diagram showing how the antenna devices according to the examples of the invention are mounted;

FIG. 4 is a graph showing the VSWR of the antenna device according to example 1 of the invention; and

FIG. 5 is a graph showing the VSWR of the antenna device according to example 2 of the invention.

### DETAILED DESCRIPTION OF THE PREFERRED EMBODIMENTS

Embodiments of the present invention will be described below by way of example, using examples 1 and 2.

### Example 1

An embodiment (example 1) of the present invention will first be described below by way of example, using an antenna device having a circuit configuration shown in FIG. 1. As shown in this figure, the antenna device 1 includes a radiating element 11, a matching circuit 12 and an RF terminal 13. It is assumed that the antenna device 1 is connected to the main body of a communication device (a portion of the communication device where the antenna device is excluded) that performs wireless communication.

The radiating element 11 is a portion that emits and receives radio waves. The matching circuit 12 includes a PIN diode 15, a control terminal 16 and a coil 17.

The PIN diode 15 is a diode that has a P-I-N structure where an I layer is interposed between a P layer and an N layer; as a direct-current bias current is varied, the capacitance between its terminals (hereinafter simply referred to as “capacitance”) varies. The PIN diode 15 has its anode connected to the radiating element 11 and its cathode connected to the RF terminal 13. (The reverse configuration is also possible). In other words, the PIN diode 15 is inserted into an RF line through which the radiating element 11 and the RF terminal 13 are connected and an RF signal is transmitted.

The control terminal 16 is connected to the anode of the PIN diode 15 via a predetermined resistor. The control terminal 16 is also connected to the main body of the communication device (for example, a communication module that is provided inside the communication device); as described later, a voltage is applied to control the capacitance of the PIN diode 15. The coil 17 is a circuit component that has a predetermined inductance; it has one end connected to the cathode of the PIN diode 15 and the other end grounded. A chip coil may be employed as the coil 17.

As described above, the matching circuit 12 has the PIN diode 15 as a capacitance element; the PIN diode 15 is controlled to vary the VSWR (voltage standing wave ratio) characteristic of the antenna device 1.

The RF terminal 13 is a terminal that is connected to the main body of the communication device (for example, the communication module that is provided inside the communication device). When the communication device wirelessly receives an RF signal, the RF signal is transmitted from the radiating element 11 to the main body of the communication device via the RF terminal 13. When the communication device wirelessly transmits the RF signal, the RF signal is transmitted from the main body of the communication device to the radiating element 11 via the RF terminal 13.

A description will now be given of the function of the antenna device 1 configured as described above.

When the communication device wirelessly receives the RF signal, the RF signal carried by the radio wave is transmitted, through the RF line in which the radiating element 11, the PIN diode 15 and the RF terminal 13 are connected sequentially, to the main body of the communication device connected to the RF terminal 13. The communication device performs predetermined processing on the RF signal transmitted as described above.

When the communication device wirelessly transmits the RF signal, the RF signal output from the main body of the communication device is transmitted in the opposite direction from that described above through the RF line to the radiating element 11. The radio wave carrying the RF signal is then emitted into the air through the radiating element 11.

Here, when a high-level voltage (a predetermined voltage) is applied to the control terminal 16, a predetermined direct current (bias current) is passed through the PIN diode 15, and thus the PIN diode 15 is turned on. In contrast, when a low-level voltage (for example, a voltage of zero volts) is applied to the control terminal 16, almost no direct current is passed through the PIN diode 15, and thus the PIN diode 15 is turned off. In this way, the PIN diode 15 is switchably controlled to be turned either on or off according to whether a voltage applied to the control terminal 16 is high or low.

The capacitance of the PIN diode 15 varies depending on whether the PIN diode 15 is on or off. Thus, depending on whether the PIN diode 15 is on or off, the VSWR of the antenna device 1 varies, that is, the frequency received by the antenna device 1 varies.

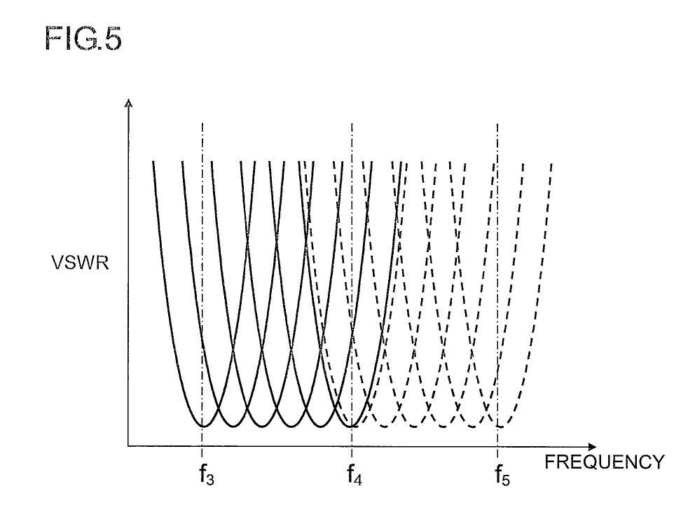

A graph showing the VSWR characteristic of the antenna device 1 is shown in FIG. 4. In the graph, the horizontal axis represents frequency, and the vertical axis represents the VSWR corresponding to the frequency. The solid-line curve in the graph represents the VSWR when the PIN diode 15 is on. The broken-line curve in the graph represents the VSWR when the PIN diode 15 is off. As shown in this figure, when the PIN diode 15 is on, the minimum VSWR is reached at a frequency f₁; in contrast, when the PIN diode 15 is off, the minimum VSWR is reached at a frequency f₂ (≠f₁).

Specifically, the antenna device 1 effectively transmits, when the PIN diode 15 is turned on, the RF signal around the frequency f₁, whereas it effectively transmits, when the PIN diode 15 is turned off, the RF signal around the frequency f₂. Thus, the communication device connected to the antenna device 1 can achieve effective wireless communication either by applying a high-level voltage to the control terminal 16 when wireless communication is performed using the RF signal around the frequency f₁ or by applying a low-level voltage to the control terminal 16 when wireless communication is performed using the RF signal around the frequency f₂.

Generally, the capacitance of a PIN diode can be varied significantly as compared with a variable capacitance diode. Thus, the antenna device 1 of this embodiment can significantly shift its resonant frequency, as compared with the case where a PIN diode is not employed as a capacitance element, without the need to use a large number of circuit components (that is, with a relatively simplified configuration).

Generally, the main characteristic of PIN diodes is that a PIN diode having a relatively low forward resistance in its “on” state has a relatively high capacitance in its “off” state and that a PIN diode having a relatively high forward resistance in its “on” state has a relatively low capacitance in its “off” state. That is, there is a trade-off between the forward resistance and capacitance of a PIN diode.

PIN diodes of various characteristics are available on the market so that a user can employ an appropriate PIN diode according to which one of the forward resistance characteristic and the capacitance characteristic is given higher priority. Thus, in consideration of a required capacitance, a transmission loss resulting from the forward capacitance and the like, the user can obtain a high-performance matching circuit 12 by selecting an appropriate PIN diode.

A PIN diode typically requires a low voltage to vary its capacitance a predetermined amount as compared with a variable capacitance diode. For example, if it is assumed that, in the matching circuit 12 shown in FIG. 1, a variable capacitance diode is used instead of the PIN diode 15, it is necessary to apply a voltage of about 3 to 5 volts to the control terminal 16 in order for the capacitance of the variable capacitance diode to be varied to some extent. However, when a PIN diode is employed as in this example, it is typically possible to vary the capacitance of the PIN diode an amount larger than that described above by applying a voltage of 1 volt or less to the control terminal 16.

Voltages that are set at standard values of communication modules and that can be output by them tend to be decreased. For example, some communication modules can only output a voltage as low as about 1.8 volts. With the matching circuit 12 incorporating the PIN diode 15 as in this example, it is quite possible to achieve control by such communication module.

Although, in this example, the matching circuit 12 incorporates only one PIN diode, a plurality of PIN diodes may be used. In this case, the PIN diodes are preferably inserted into the RF line such that, for example, they are connected in series to each other. In this way, it is possible to increase the range of variations in the capacitance of the matching circuit 12. This makes it possible to vary the VSWR characteristic of the antenna device 1 more significantly.

### Example 2

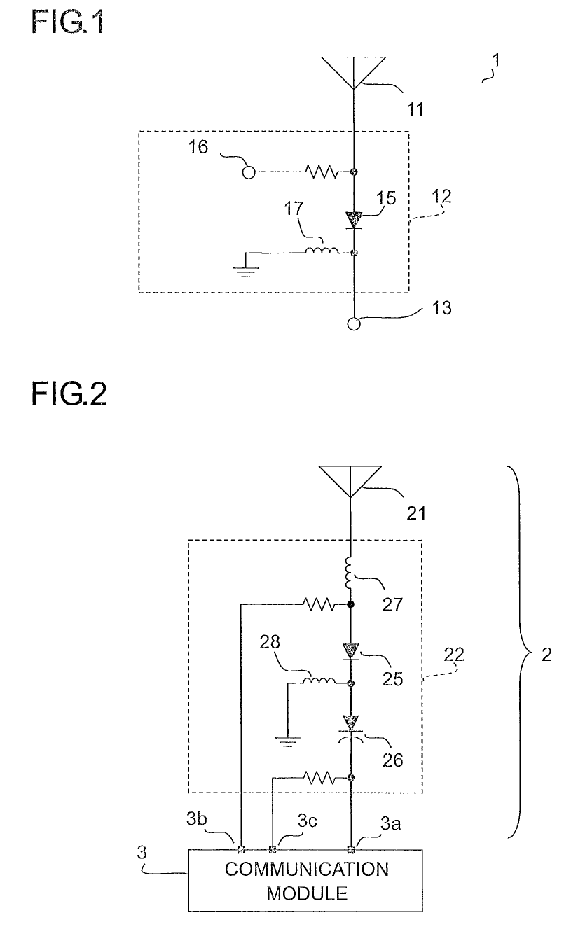

Another embodiment (example 2) of the present invention will now be described below by way of example, using a communication device having a configuration shown in FIG. 2. As shown in this figure, the communication device is composed of an antenna device 2, a communication module 3 and other components.

The antenna device 2 includes a radiating element 21 and a matching circuit 22. The matching circuit 22 has a PIN diode 25, a variable capacitance diode 26 and coils 27 and 28. It is easy to vary the capacitance of the variable capacitance diode 26 in an analog manner (continuously), as compared with the PIN diode 25, by controlling a direct-current voltage applied thereto. Chip coils may be used as the coils 27 and 28.

The coil 27 has one end connected to the radiating element 21 and the other end connected to the anode of the PIN diode 25. The cathode of the PIN diode 25 is connected to the anode of the variable capacitance diode 26. The node between the PIN diode 25 and the variable capacitance diode 26 is grounded via the coil 28. As described above, the PIN diode 25, the variable capacitance diode 26 and the coil 27 are connected in series to each other over the RF line through which the radiating element 21 and an RF terminal 3a are connected and the RF signal is transmitted.

The matching circuit 22 has, as capacitance elements, the PIN diode 25, the variable capacitance diode 26 and the like. These elements are controlled to vary the VSWR characteristic of the antenna device 2, that is, to vary the frequency received by the antenna device 2.

The communication module 3 is a module that is provided inside the communication device and that performs various types of processing on communication; it has the RF terminal 3a, a GPIO terminal 3b and a DAC terminal 3c. The RF terminal 3a is connected to the RF terminal of the antenna device 2 (a terminal provided on the cathode side of the variable capacitance diode 26). The GPIO terminal 3b is connected to the node between the coil 27 and the PIN diode 25 via a resistor. The DAC terminal 3c is connected to the cathode of the variable capacitance diode 26 via a resistor.

When the RF signal is wirelessly transmitted, the communication module 3 outputs an electric power containing the RF signal to the antenna device 2 via the RF terminal 3a. Thus, the RF terminal 3a can be regarded as the feeding point of the antenna device 2. Likewise, the RF line through which the radiating element 21 and the RF terminal 3a are connected and the RF signal is transmitted can be regarded as the feeding line. The matching circuit 22 and the PIN diode 25 can be regarded as being inserted around the feeding point into the feeding line.

The communication module 3 outputs a high-level voltage or a low-level voltage (a voltage for controlling the capacitance of the PIN diode 25) via the GPIO terminal 3b. When a high-level voltage is output, a predetermined direct current (bias current) is passed through the PIN diode 25, and thus the PIN diode 25 is turned on. In contrast, when a low-level voltage is output, almost no direct current is passed through the PIN diode 25, and thus the PIN diode 25 is turned off. In this way, the PIN diode 25 is switchably controlled to be turned either on or off according to whether a voltage output from the communication module 3 is high or low.

The communication module 3 outputs a voltage for controlling the capacitance of the variable capacitance diode 26 via the DAC terminal 3c. The communication module 3 can vary the magnitude of the voltage output via the DAC terminal 3c in an analog manner. Thus, the capacitance of the variable capacitance diode 26 is controlled in an analog manner according to the magnitude of the voltage output from the communication module 3.

A graph showing the VSWR of the antenna device 2 is now shown in FIG. 5. In the graph, the horizontal axis represents frequency, and the vertical axis represents the VSWR corresponding to the frequency. The solid-line curves in the graph represent the VSWR when the voltage output via the DAC terminal 3c is gradually varied, with the PIN diode 25 in its on state. The broken-line curves in the graph represent the VSWR when the voltage output via the DAC terminal 3c is gradually varied, with the PIN diode 25 in its off state.

As shown in the graph, when the PIN diode 25 is in its on state, the voltage output via the DAC terminal 3c is controlled in an analog manner, and thus the frequency at which the minimum VSWR of the antenna device 2 is reached is controlled, in an analog manner, to fall within the range of f₃ to f₄. When the PIN diode 25 is in its off state, the voltage output via the DAC terminal 3c is controlled in an analog manner, and thus the frequency at which the minimum VSWR of the antenna device 2 is reached is controlled, in an analog manner, to fall within the range of f₄ to f₅. Specifically, in consideration of the control of the voltage output via the GPIO terminal 3b, the frequency at which the minimum VSWR of the antenna device 2 is reached is controlled, in an analog manner, to fall within the approximate range of f₃ to f₅.

A description will now be given of the function of the communication device of this example.

When the communication device wirelessly receives the RF signal, the RF signal carried by the radio wave is transmitted, through the RF line in which the radiating element 21, the coil 27, the PIN diode 25, the variable capacitance diode 26 and the RF terminal 3a are connected sequentially, to the communication module 3. The communication module 3 then performs predetermined processing on the RF signal transmitted as described above.

When the communication device wirelessly transmits the RF signal, the RF signal output from the communication module 3 is transmitted in the opposite direction from that described above through the RF line to the radiating element 21. The radio wave carrying the RF signal is then emitted into the air through the radiating element 21.

The communication module 3 outputs, via the GPIO terminal 3b or the DAC terminal 3c, a voltage corresponding to a frequency used in wireless communication to control either or both of the capacitances of the PIN diode 25 and the variable capacitance diode 26. Specifically, the voltage is output such that the minimum VSWR of the antenna device 2 is reached at the frequency used in the wireless communication. Thus, the communication device can perform wireless communication efficiently (so as to minimize the transmission loss of the RF signal).

Attention is now focused on the range over which the VSWR characteristic of the antenna device 2 is controlled. In this example, since the PIN diode 25 is employed as a variable capacitance element in the matching circuit 22, the VSWR characteristic can be controlled over a wide range with a relatively simplified configuration. If it is assumed that the PIN diode is not employed in the matching circuit, it is probably necessary to use, for example, a large number of variable capacitance diodes in order to achieve a control range equal to that achieved by the matching circuit 22 of this example.

Moreover, in this example, since the variable capacitance diode 26 is employed as a variable capacitance element in the matching circuit 22, the VSWR characteristic can be controlled in an analog manner. Thus, in this example, both the PIN diode 25 and the variable capacitance diode 26 are employed as variable capacitance elements in the matching circuit 22, and this allows the VSWR characteristic to be controlled in an analog manner over a wide range.

Although, in this example, the matching circuit 22 incorporates only one PIN diode and one variable capacitance diode, a plurality of PIN diodes and variable capacitance diodes may be used. In this case, the PIN diodes and variable capacitance diodes are preferably inserted into the RF line such that, for example, they are connected in series to each other. In this way, it is possible to control the VSWR characteristic of the antenna device 2 over a wider range.

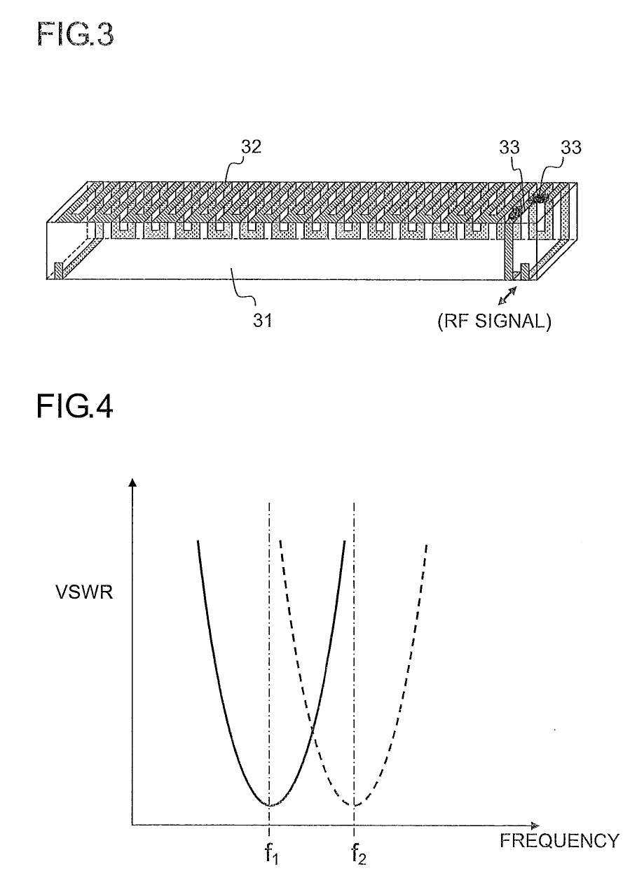

How the antenna device 2 is mounted will now be described below with reference to FIG. 3.

As shown in this figure, the antenna device 2 is configured such that a conductor pattern 32 corresponding to the radiating element 21 and the like is formed on the surface of a substantially rectangular-parallelepiped-shaped dielectric member 31. Specifically, the conductor pattern 32 is formed in a meandering shape so as to reach a plurality of sides of the dielectric member 31. The end and nearby portions of the conductor pattern 32 (on the light side of FIG. 3) correspond to the RF terminal of the antenna device 2, and it is connected to the RF terminal 3a of the communication module. With chip components 33 that will be described later and that constitute the matching circuit 22, not only the RF terminal but also a control terminal and the like are formed as the conductor pattern on the dielectric member. In FIG. 3, the dielectric member 31 is shown translucently in order to make the shape of the conductor pattern 32 and the like more easily understandable.

Since the conductor pattern 32 is formed in a meandering shape as described above, the size of the radiating element 21 can be reduced. Moreover, since the conductor pattern 32 is formed on a plurality of sides of the dielectric member 31, the size of the radiating element 21 can be further reduced. The conductor pattern 32 may be formed in a shape other than a meandering shape, such as a helical shape, an inverted F-shape or an inverted L-shape. Since the shapes of the conductor pattern are disclosed in JP-A-2005-341547 and other documents, and hence they are known, the detailed description thereof will not be given herein.

The elements (the PIN diode 25, the variable capacitance diode 26 and the coils 27 and 28) in the matching circuit 22 or the chip components 33 that constitute the entire matching circuit 22 are mounted on the dielectric member 31. Thus, it is not necessary to provide another space in which the chip components 33 are mounted. This makes it possible to minimize the space in which components are mounted.

With the above-described mounting method, it is possible to minimize the size of the antenna device 2. This helps incorporate the antenna device 2 into a compact (for example, portable) communication device.

### CONCLUSION

As described above, the antenna devices 1 and 2 of the embodiments of the present invention respectively include the radiating elements 11 and 21 and the matching circuits 12 and 22 that are connected to the radiating elements and provided with the capacitance elements. Each of the PIN diodes 15 and 25 is employed as at least one of the capacitance elements, and the capacitances of the PIN diodes are controlled such that the resonant frequencies of the antenna devices 1 and 2 are controlled.

In the antenna devices 1 and 2, the number of capacitance elements that are needed to shift the resonant frequency thereof by a predetermined amount can be reduced, as compared with antenna devices in which the PIN diodes 15 and 25 are not employed as the capacitance elements in the matching circuits 12 and 22. Thus, it is possible to simplify the matching circuits 12 and 22 and reduce the sizes thereof with ease.

As compared with antenna devices in which the PIN diodes 15 and 25 are not employed as the capacitance elements in the matching circuits 12 and 22, it is possible to achieve control with a low voltage and hence vary, with a low voltage, frequency characteristics such as a VSWR. Thus, unlike the antenna device of patent document 2 described previously, it is not necessary to connect a control pattern or the like to the radiating element, and this makes it easy to prevent as much as possible a decrease in radiation efficiency.

Although, in the above-described examples, the RF signals are wirelessly transmitted and received, the RF signals may be wirelessly either transmitted or received.

The present invention is not limited to the embodiments described above. Many modifications and variations are possible without departing from the spirit of the invention. Technical means used in the examples may be combined together unless the combination is impracticable.

As described above, with the antenna device of the invention, it is possible to reduce the number of capacitance elements that are needed to shift its resonant frequency by a predetermined amount as compared with an antenna device in which the PIN diode is not employed as the capacitance element in the matching circuit. Thus, it is possible to simplify the matching circuit and reduce the size thereof with ease.

As compared with the antenna device in which the PIN diode is not employed as the capacitance element in the matching circuit, it is also possible to shift the resonant frequency with a low voltage. It is also possible to vary frequency characteristics such as a VSWR by controlling the matching circuit. Thus, unlike the antenna device of patent document 2 described previously, it is not necessary to connect a control pattern or the like to the radiating element, and this makes it easy to prevent as much as possible a decrease in radiation efficiency.

1. An antenna device comprising:
a radiating element; and
a matching circuit connected to the radiating element and provided with capacitance elements,
wherein a PIN diode is employed as at least one of the capacitance elements, and a capacitance of the PIN diode is controlled such that a resonant frequency is controlled.

2. The antenna device of claim 1, further comprising:
an RF terminal connected to the radiating element through the matching circuit,
wherein the PIN diode is inserted into an RF line through which the radiating element and the RF terminal are connected and through which an RF signal is transmitted.

3. The antenna device of claim 1,
wherein the PIN diode is inserted into a feeding line connecting the radiating element and a feeding point.

4. The antenna device of claim 1,
wherein, as said PIN diode, a plurality of PIN diodes are included.

5. The antenna device of claim 2,
wherein a variable capacitance diode employed as one of the capacitance elements is inserted into the RF line so as to be connected in series to the PIN diode.

6. The antenna device of claim 1,
wherein the radiating element is a conductor pattern formed on a predetermined dielectric member.

7. The antenna device of claim 6,
wherein the conductor pattern is formed in one of a meandering shape, a helical shape, an inverted F-shape and an inverted L-shape.

8. The antenna device of claim 6,
wherein the conductor pattern is formed in a meandering shape on a plurality of surfaces of the dielectric member.

9. The antenna device of claim 6,
wherein a chip coil is inserted into a line connecting the radiating element and the PIN diode.

10. The antenna device of claim 6,
wherein a variable capacitance diode employed as one of the capacitance elements is inserted in series into the RF line, a chip coil is inserted into a line connecting the radiating element and the PIN diode and a chip component constituting one of the PIN diode, the variable capacitance diode, the chip coil and the matching circuit is mounted on the dielectric member.

11. A communication device comprising:
the antenna device of claim 1; and
a communication module that wirelessly communicates externally through the antenna device and that controls a capacitance of the PIN diode.

12. A communication device comprising:
the antenna device of claim 5; and
a communication module that wirelessly communicates externally through the antenna device and that controls a capacitance of the PIN diode and a capacitance of the variable capacitance diode.

13. The communication device of claim 11,
wherein the communication module performs the control according to a frequency used in the wireless communication, and a VSWR of the antenna device is controlled by the control.

14. The communication device of claim 12,
wherein the communication module performs the control according to a frequency used in the wireless communication, and a VSWR of the antenna device is controlled by the control.
